(19) United States
(12) Patent Application Publication
(10) Pub. No.: US 2023/0407922 A1
(43) Pub. Date: Dec. 21, 2023

(54) MOTOR ADAPTER AND COVER FOR ROTATING MACHINERY

(71) Applicant: Dodge Industrial, Inc., Oxford, CT (US)

(72) Inventors: David W. Keech, Simpsonville, SC (US); John W. DeJong, Greenville, SC (US); Thomas J. Kolans, Piedmont, SC (US); William M. Tarr, Simpsonville, SC (US); Joshua R. Wald, Greenville, SC (US)

(73) Assignee: Dodge Industrial, Inc., Oxford, CT (US)

(21) Appl. No.: 18/210,940

(22) Filed: Jun. 16, 2023

Related U.S. Application Data
(60) Provisional application No. 63/352,775, filed on Jun. 16, 2022.

(51) Int. Cl. F16D 1/02

(52) U.S. Cl. CPC F16D 1/02; F16D 2300/26; F16D 2300/08

(57) ABSTRACT

An adapter for connecting stationary portions of two housing that are connected via a rotatable shaft. The adapter includes a hollow body that extends from a first axial end to a second axial end. A first fastening feature is arranged proximate the first axial end and a second fastening feature is arranged proximate a second axial end. The hollow body has an interior area that extends from a first lateral opening that is located proximate the first axial end to a second lateral opening that is located proximate the second axial end. One or more longitudinal openings are located between the first axial end and the second axial end. The one or more longitudinal openings are configured to access the interior area.

### CROSS REFERENCE TO RELATED APPLICATION

This application claims the benefit of prior-filed, co-pending U.S. Provisional Patent Application No. 63/352,775, filed on Jun. 16, 2022, the entire contents of which is incorporated herein by reference in its entirety.

### FIELD OF THE INVENTION

The present invention is directed to an adapter and cover for a rotary drive assembly, and more particularly to an adapter that allows inspection, maintenance, and replacement of a rotating machinery coupling without removing the motor, and a cover that protects users from accidental contact with the rotating machinery and creates a liquid and dustproof seal on the adapter.

### BACKGROUND

Various rotating machinery includes a drive unit (e.g., a motor) having a drive shaft extending therefrom and a driven unit (e.g., a gear reducer or gearbox) having a driven shaft extending therefrom. A coupling is used to connect the drive shaft to the driven shaft. Traditionally, the coupling is exposed, posing the safety hazard to users of accidental contact with the rotating coupling. Recently, coupling guard adapters have been employed to improve the safety of the users. However, these coupling guard adapters do not permit inspection, maintenance, and replacement of the couplings without removing the coupling guard and/or the motor, thereby posing the safety hazard to user of having to move heavy machinery components. Additionally, these coupling guard adapters do not protect the coupling from contaminates such as various liquids and debris.

Thus, there is a need for an improved rotating machinery adapter and cover that addressed at least the problems described above.

### SUMMARY

There is disclosed herein an adapter for connecting stationary portions of two housing that are connected via a rotatable shaft. The adapter includes a hollow body that extends from a first axial end to a second axial end. A first fastening feature is arranged proximate the first axial end and a second fastening feature is arranged proximate a second axial end. The hollow body has an interior area that extends from a first lateral opening that is located proximate the first axial end to a second lateral opening that is located proximate the second axial end. One or more longitudinal openings are located between the first axial end and the second axial end. The one or more longitudinal openings are configured to access the interior area.

In some embodiments, the adapter includes one or more retainers that are located on an exterior surface of the hollow body.

In some embodiments, the one or more longitudinal openings are configured to receive a removable cover.

In some embodiments, the hollow body includes a drip ledge that is located proximate one or more of the first axial end and the second axial end.

In some embodiments, the hollow body is adjustable to locate the one or more longitudinal openings in a predetermined position.

There is disclosed herein a cover for an adapter for connecting stationary portions of two housings that are connected via a rotatable shaft. The cover includes one or more sheet segments that extend longitudinally from a first axial end to a second axial end and extends laterally from a first lateral end to a second lateral end. The one or more sheet segments includes two or more mounting areas thereon that are configured to secure the one or more sheet segments over at least a portion of the adapter.

In some embodiments, the two or more mounting areas include a first flange that is located along the first lateral end and a second flange that is located along the second lateral end.

In some embodiments, the first flange and the second flange each have one or more apertures extending therethrough for receiving a fastener.

In some embodiments, one or more of the first flange and the second flange include a fastener retention feature that is configured to hold the fastener during installation of the cover on the adapter.

In some embodiments, the fastener retention feature includes a washer and nut and/or a bolt head holder.

In some embodiments, the one or more sheet segments include a gasket that is secured to at least a portion thereof for sealing against the adapter.

In some embodiments, a lip extends around a periphery of the one or more sheet segments for limiting compression of the gasket to a predetermined magnitude.

In some embodiments, a recess is formed in an underside of the one or more sheet segments. The recess is configured to retain the gasket therein and is defined by a lip for limiting compression of the gasket to a predetermined magnitude.

In some embodiments, the one or more sheet segments include an anti-slip feature thereon.

In some embodiments, the anti-slip feature includes a notch formed in a peripheral edge of the one or more sheet segments for axially retaining the cover on the adapter.

In some embodiments, the one or more sheet segments is opaque.

In some embodiments, at least a portion of the one or more sheet segments is transparent or translucent.

In some embodiments, the one or more sheet segments is flexible for selectively forming around the adapter.

In some embodiments, the first lateral end and the second lateral end are parallel to one another to form a cylindrical shape when the cover is assembled.

In some embodiments, the first lateral end and the second lateral end are arranged at an angle to one another to form a conical shape when the cover is assembled.

There is herein further disclosed an adapter and cover assembly that includes the cover of any of the preceding cover embodiments installed on the adapter of any the preceding adapter embodiments.

In some embodiments, the cover includes a size adjustment arrangement that is configured to selectively fit the cover to a range of adapter sizes.

In some embodiments, the size adjustment arrangement includes an adjustable gap that is located between the first flange and the second flange. The gap is adjustable with the fasteners that extend through the apertures in the first flange and the second flange.

In some embodiments, the one or more retainers located on an exterior surface of the hollow body of the adapter is positioned in the anti-slip feature of the one or more sheet segments of the cover to axially retain the cover on the adapter.

In some embodiments, the adapter and cover assembly includes two of the one or more sheet segments wrapped around a respective half of the adapter. Each of the two sheet segments are secured to one another by respective ones of the first flange and the second flange and the fasteners.

There is further disclosed herein a rotary drive assembly that includes a drive unit and a driven unit. The drive unit includes a rotatable drive shaft that extends outwardly from a drive unit housing. The drive unit housing surrounds the drive shaft and has a first axially facing mounting arrangement thereon. The driven unit includes a rotatable driven shaft that extends outwardly from a driven unit housing. The driven unit housing surrounds the driven shaft and has a second axially facing mounting arrangement thereon. A coupling is removably secured to the drive shaft and the driven shaft thereby connecting the drive shaft to the driven shaft. The second fastening feature of the adapter of any of the preceding adapter embodiments is secured to the first axially facing mounting arrangement of the drive unit housing and the first fastening feature of the adapter is secured to the second axially facing mounting arrangement of the driven unit housing. The coupling is positioned in the interior area of the adapter and is accessible via the one or more longitudinal openings of the adapter. The cover of any of the preceding cover embodiments is installed on the adapter.

There is further disclosed herein, an adapter and cover assembly for connecting stationary portions of two housings that are connected via a rotatable shaft. The adapter includes a support structure that extends around the shaft and has a hollow body extending from a first axial adapter-end to a second axial adapter-end. The hollow body has a first fastening feature arranged proximate the first axial adapter-end and a second fastening feature arranged proximate the second axial adapter-end. The hollow body has an interior area that extends from the first axial adapter-end to the second axial adapter-end. The first axial adapter-end has a first lateral opening and the second axial adapter-end having a second lateral opening. The first fastening feature is fixedly connected to a first of the two housings and the second fastening feature fixedly connected to a second of the two housings. The hollow body has a longitudinal opening located between the first axial adapter-end and the second axial adapter-end. The longitudinal opening is in communication with the interior area. The cover includes a sheet segment that extends longitudinally from a first axial cover-end to a second axial cover-end and extends laterally from a first lateral cover-end to a second lateral cover-end. The cover has two mounting areas each being removably secured to the adapter. The two mounting areas each have a first flange located along the first lateral end and a second flange located along the second lateral end A gasket is positioned between the sheet segment and the adapter. A lip extends around a periphery of the sheet segment for limiting compression of the gasket to a predetermined magnitude, so that the cover is removably and sealably secured over the longitudinal opening in the adapter by mating of the first flange and the second flange.

### BRIEF DESCRIPTION OF THE DRAWINGS

Referring now to the Figures, which are exemplary embodiments, and wherein the like elements are numbered alike:

FIG. 1 is a side view of a rotary drive assembly with an adapter positioned thereon;

FIG. 2 is a perspective view of the adapter of FIG. 1;

FIG. 3 is a side view of the rotary drive assembly of FIG. 1 with an opaque cover installed on the adapter;

FIG. 4 is a side view of the rotary drive assembly of FIG. 1 with a cover having a transparent or translucent portion installed on the adapter;

FIG. 5 is an enlarged view of detail A of FIG. 1 showing the adapter positioned on the rotary drive assembly;

FIG. 6 is a top view of a sheet segment of the cover of FIG. 3 before being selectively formed to partially fit around the adapter;

FIG. 7A is a cross-sectional view of the sheet segment of FIG. 6 taken along section line B-B;

FIG. 7B is an enlarged cross-sectional view of detail E of FIG. 7A showing the first axial end of the cover;

FIG. 7C is an enlarged cross-sectional view of detail D of FIG. 7A showing the second axial end of the cover;

FIG. 8 is a perspective view of the sheet segment of FIG. 6 after being selectively formed to partially fit around the adapter;

FIG. 9 is a partial perspective view of the cover having two sheet segments selectively formed to fit around the adapter;

FIG. 10 is a side view of the cover of FIG. 9;

FIG. 11 is an enlarged view of detail C of FIG. 8 showing a fastener and a fastener retention feature of the cover;

FIG. 12 is a top view of the sheet segment of FIG. 8;

FIG. 13 is a bottom view of the sheet segment of FIG. 8;

FIG. 14 is a side view of the sheet segment of FIG. 8;

FIG. 15A is an enlarged view of detail G of FIG. 14 showing a fastener and a retention clip attached thereto;

FIG. 15B is a perspective view of the fastener and retention clip arrangement of FIG. 15A; and

FIG. 16 is a cross-sectional view of the sheet segment of FIG. 8 taken along section line F-F.

### DETAILED DESCRIPTION

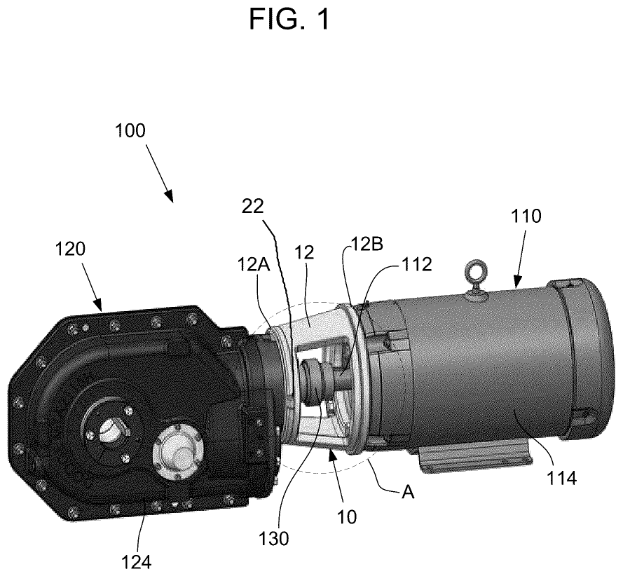

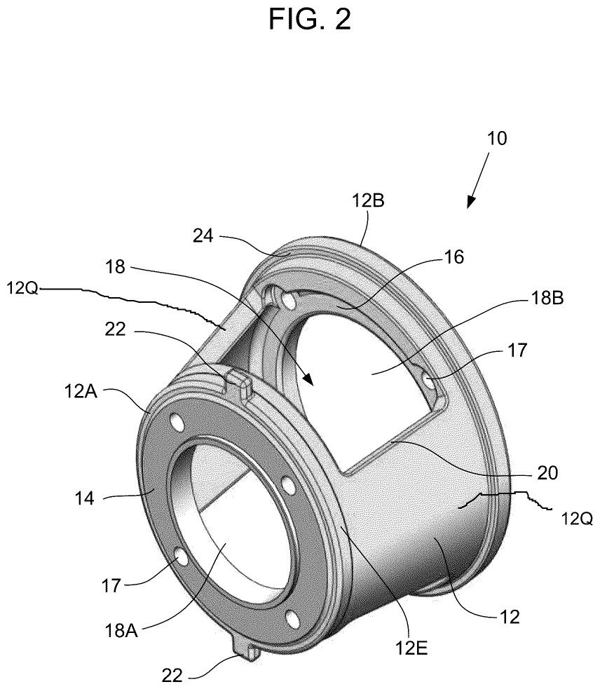

As shown in FIG. 1, an adapter 10 is mounted on a rotary drive assembly 100. The adapter 10 includes a hollow body 12 that extends from a first axial end 12A to a second axial end 12B. As shown in FIG. 2, a first fastening feature 14 is arranged proximate the first axial end 12A, and a second fastening feature 16 is arranged proximate the second axial end 12B. In some embodiments, the first fastening feature 14 and the second fastening feature 16 each include a plurality of apertures 17 that are configured to align with corresponding apertures 117 of the rotary drive assembly 100 and receive fasteners 118 therethrough, as discussed in detail below. The hollow body 12 has an interior area 18 that extends from a first lateral opening 18A that is located proximate the first axial end 12A to a second lateral opening 18B that is located proximate the second axial end 12B. Two longitudinal openings 20 are located between the first axial end 12A and the second axial end 12B. The longitudinal openings 20 are configured to permit access to the interior area 18 for example to install, remove and inspect a coupling 130, as shown in FIG. 1. For example, the openings each extend an axial length about equal to about 80 percent of an overall axial length of the hollow body 12, and each extend a circumferential arc 80 to 120 degrees. The openings 20 are shown opposite one another. While two openings 20 are shown opposite one another, the present disclosure is not limited in this regard as only one opening may be employed or more than two openings may be employed. Two retainers 22 (e.g., a tab) are located on an exterior surface 12E of the hollow body 12. The retainers 22 protrude radially outward from the exterior surface 12E. The retainers 22 are formed integrally with the hollow body 12, as shown in FIG. 2 and shown 180 degrees apart from one another. However, the present disclosure is not limited in this regard as the retainers 22 may be removably attached to the hollow body 12, for example the retainers may be pegs screwed into a respective threaded bore in the hollow body 12. While two retainers 22 are shown and described being 180 degrees apart, the present disclosure is not limited in this regard as only one retainer may be employed or more that two retainers may be employed at symmetrically spaced or staggered locations circumferentially around the exterior surface 12E. The one or more retainers 22 are configured to axially retain and orient a cover 30 over the one or more longitudinal openings 20, as discussed in detail below. A drip ledge 24 extends circumferentially around the exterior surface 12E of the hollow body 12 and shown if FIG. 2 being located proximate the second axial end 12B. However, the present disclosure is not limited in this regard, as another drip ledge may be located proximate the first axial end 12A. The drip ledge 24 is configured to protect the interface between the adapter 10 and the cover 30 from contaminates (e.g., liquids, debris, dust, etc.) when the rotary drive assembly 100 is vertically oriented. For example, in some embodiments the adapter 10 is mounted on a rotary drive assembly 100 that includes a drive unit 110 (e.g., a motor) and the rotary drive assembly 100 is vertically oriented such that the drive unit 110 is directly above the adapter 10. In such embodiments, the drip ledge 24 prevents liquids, such as rainwater, running down the drive unit 110 from encountering the interface between the adapter and the cover 30. In the embodiment shown in the figures, the adapter 10 has a conical cross-sectional shape. However, the present disclosure is not limited in this regard and contemplates embodiments in which the adapter 10 has different cross-sectional shapes, such as cylindrical, rectangular, hexagonal, octagonal, etc. The adapter 10 is made from cast or gray iron, ductile iron, aluminum, or zinc. In some embodiments, depending on the size and loading, the adapters are made from plastic. The adapter 10 is cast or molded, but the adapter 10 can be machined from a solid piece of material or depending on material, or 3D printed.

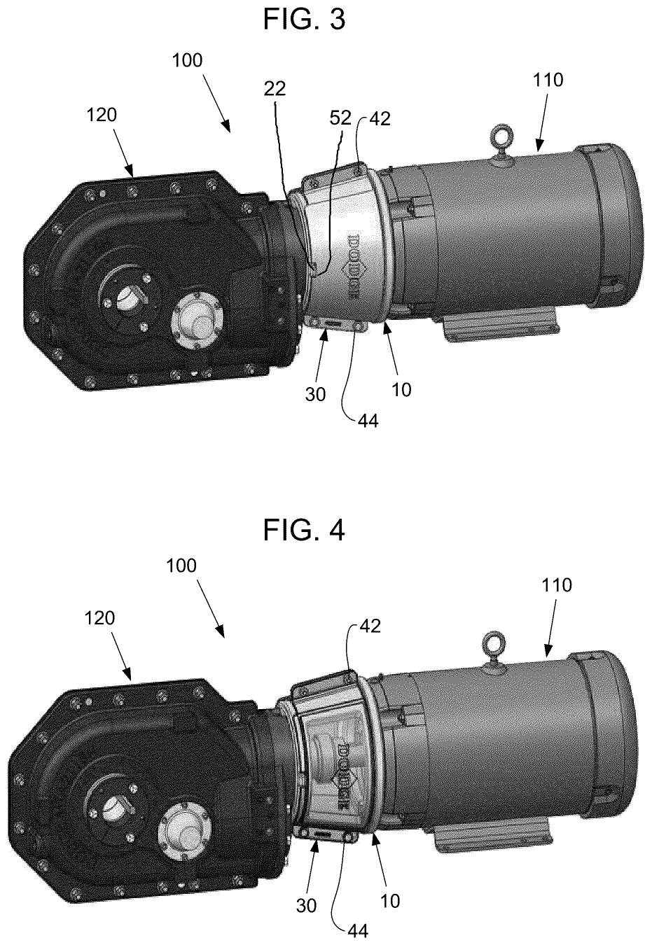

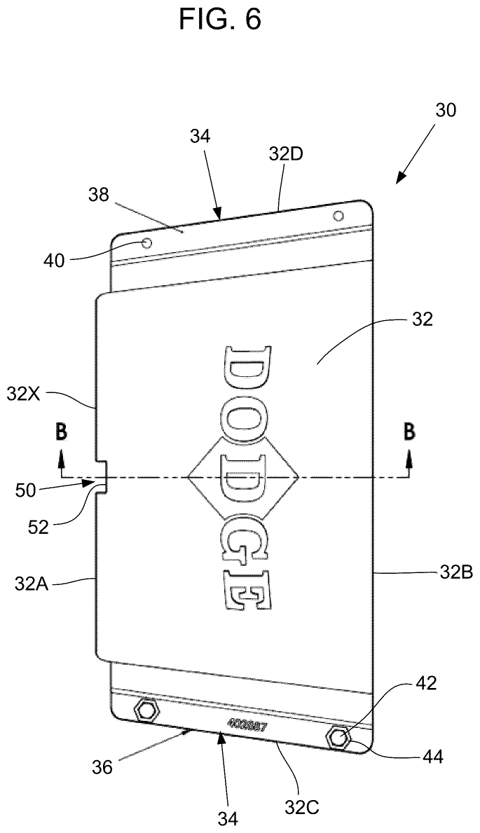

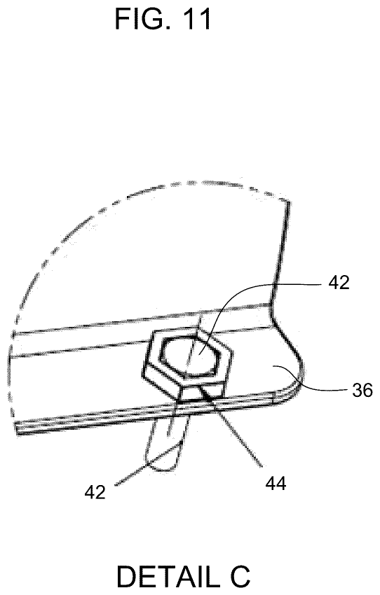

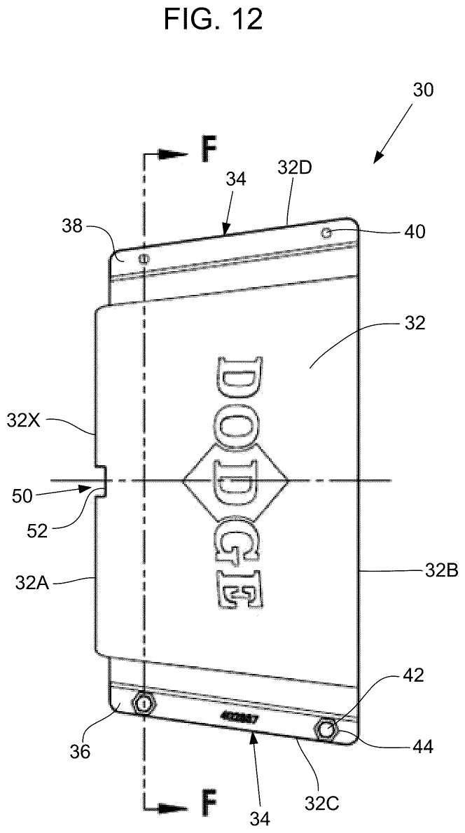

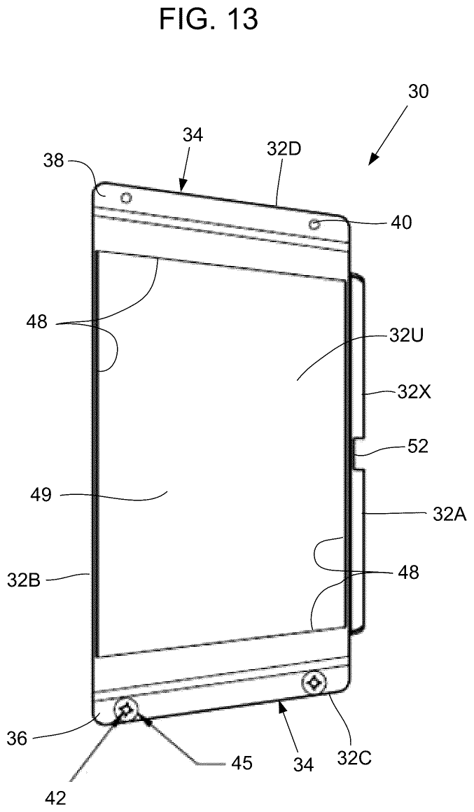

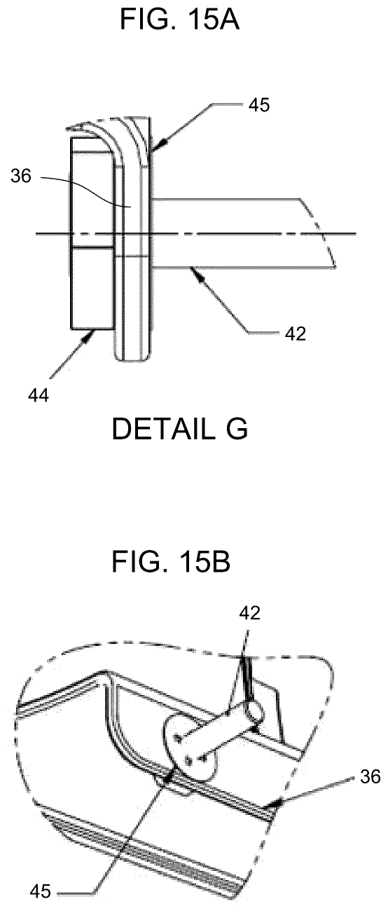

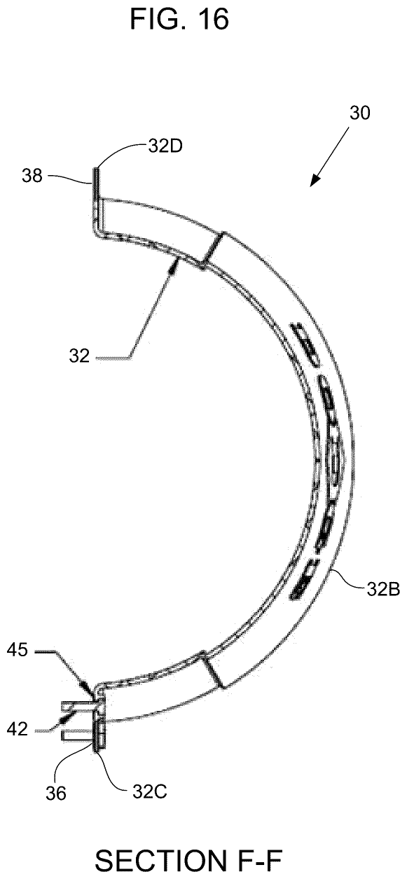

As shown in FIG. 3, the one or more longitudinal openings 20 are configured to receive a removable cover 30. As shown in FIG. 6, the cover 30 includes a sheet segment 32 that extends longitudinally from a first axial end 32A to a second axial end 32B and extends laterally from a first lateral end 32C to a second lateral end 32D. The sheet segment 32 includes two or more mounting areas 34 that are configured to secure the sheet segment 32 over at least a portion of the adapter 10. In some embodiments, the two or more mounting areas 34 include a first flange 36 that is located along the first lateral end 32C and a second flange 38 that is located along the second lateral end 32D. The first flange 36 and the second flange 38 each include one or more apertures 40 extending therethrough for receiving a fastener 42 (e.g., a threaded bolt with bolt head). As shown in FIGS. 6, 8, 9, 11, and 12, one or more of the first flange 36 and the second flange 38 include a fastener retention feature 44 that is configured to hold the fastener 42 during installation of the cover 30 on the adapter 10. The fastener retention feature 44 includes a washer and nut, a bolt head holder, or a combination thereof. However, the present disclosure is not limited in this regard and contemplates embodiments in which the fastener retention feature 44 includes any other fastener retention means known in the art. In some embodiments, a retention clip 45 is positioned on the fastener 42 after the fastener 42 is inserted through the aperture 40 of the first flange 36, as shown in FIGS. 13-16. As shown in FIGS. 15A-15B, the retention clip 45 abuts the first flange 36 and provides a friction fit over the fastener 42 to secure the fastener 42 in place during installation of the cover 30 on the adapter 10. In some embodiments, the retention clip 45 is an annular washer that has a plurality of angled prongs that are configured to snap within the threads of a threaded fastener 42 (e.g., threaded bolt, screw, etc.) to resist removal of the fastener 42 from the aperture 40. The cover 30 is formed of a flexible acrylonitrile butadiene styrene (“ABS”) material, but the present disclosure is not limited in this regard and contemplates embodiments in which the cover 30 is formed of any other flexible plastics or any other flexible material known in the art.

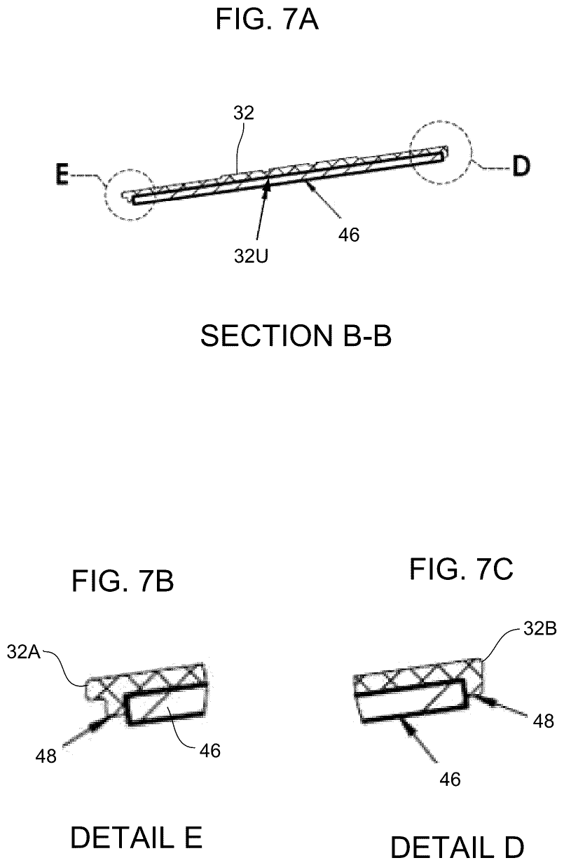

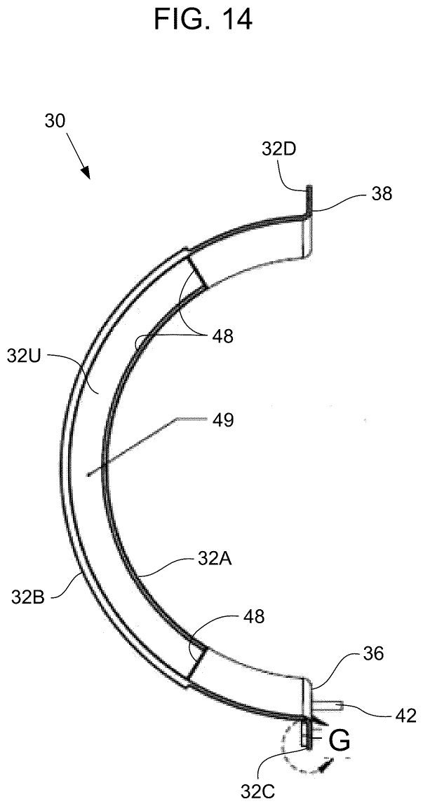

As shown in FIGS. 7A-7C, a gasket 46 is secured to at least a portion of the sheet segment 32 for sealing the sheet segment 32 against the adapter 30. In the embodiment shown in the figures, the gasket 46 is secured to an underside 32U of the sheet segment 32. However, the present disclosure is not limited in this regard and contemplates embodiments in which the gasket 46 is secured to different portions of the sheet segment 32. A lip 48 extends around a periphery of the sheet segment 32 for limiting compression of the gasket 46 to a predetermined magnitude. As shown in FIGS. 7B-7C, the lip 48 protrudes from the underside 32U of the sheet segment 32 and extends around the periphery thereof to limit the compression of the gasket 46. In some embodiments, the gasket 46 is positioned within a recess 49 that is formed in the underside 32U of the sheet segment 32, as shown in FIGS. 13-14. The recess 49 is defined by the lip 48 such that when the gasket 46 is positioned within the recess 49, the lip 48 limits compression of the gasket 46 to a predetermined magnitude. The gasket 46 has dimensions greater than those of the longitudinal opening 20 of the adapter 10 such that when the cover 30 is installed on the adapter 10, the gasket 46 forms a seal on the exterior surface 12E surrounding the longitudinal opening 20.

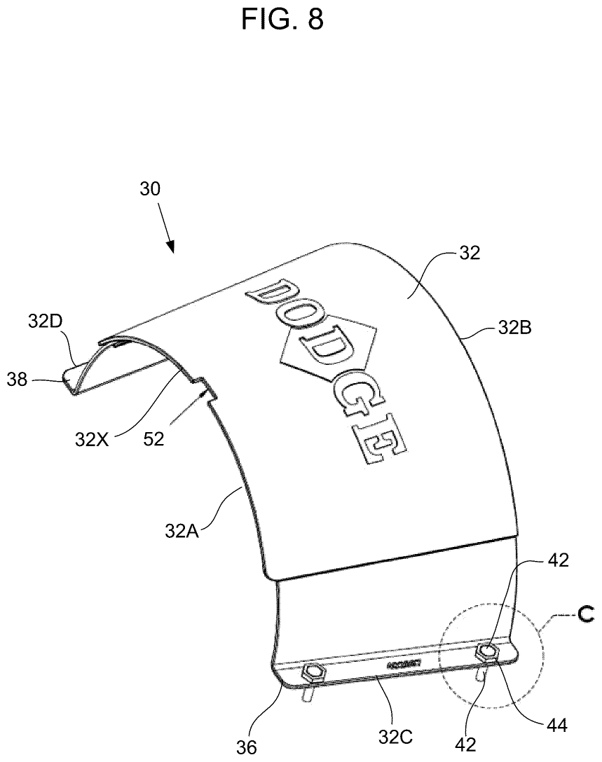

As shown in FIGS. 6, 8 12, and 13, the sheet segment 32 includes an anti-slip feature 50. In some embodiments, the anti-slip feature 50 includes a notch 52 formed in a peripheral edge 32X of the sheet segment 32. The notch 52 is configured to receive the retainer 22 of the adapter 10 to axially and circumferentially retain the cover 30 on the adapter 10. Although the anti-slip feature 50 shown in the figures includes the notch 52, the present disclosure is not limited in this regard and contemplates embodiments in which the anti-slip feature 50 includes any other means known in the art for axially retaining the cover 30 on the adapter 10.

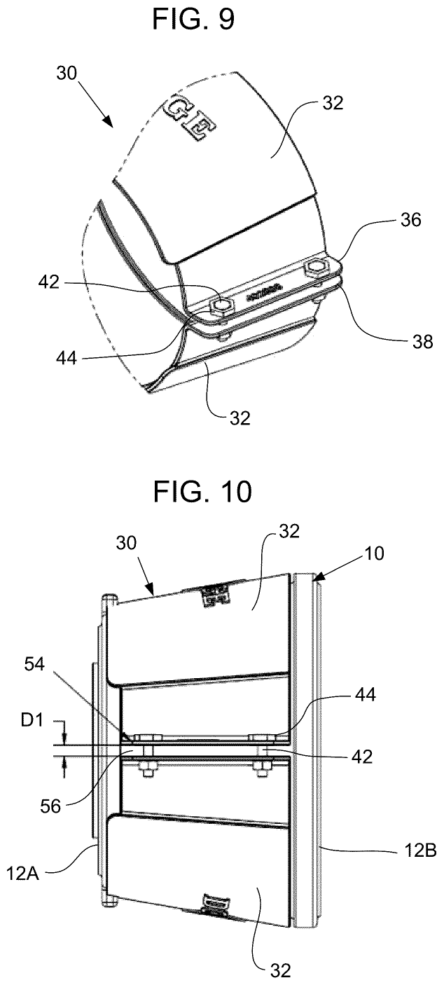

As shown in FIGS. 8, 12-14, and 16, the sheet segment 32 is flexible for selectively forming the sheet segment 32 around the adapter 10. In some embodiments, the first flange 36 and the second flange 38 are formed during manufacturing (i.e., pre-bent). In some embodiments, the first flange 36 and the second flange 38 are formed just prior to or during installation (i.e., bent when the sheet segment 32 is formed around the adapter 10). In some embodiments, two or more sheet segments 32 are wrapped around respective portions of the adapter 10 and each of the sheet segments 32 are secured to the adjacent sheet segments 32 by respective ones of the first flange 36 and the second flange 38 and the fasteners 42. For example, FIG. 9 shows a cover 30 having two sheet segments 32 selectively formed to wrap around respective halves of the adapter 10, and FIG. 10 shows the cover 30 installed on the adapter 10. The first flange 36 of the first sheet segment 32 is secured to the second flange 38 of the second sheet segment 32 via the fasteners 42, and the second flange 38 of the first sheet segment 32 is secured to the first flange 36 of the second sheet segment 32 via the fasteners 42. FIGS. 3-4 show the cover 30 of FIG. 9 wrapped around and secured to the adapter 10. The first lateral end 32C and the second lateral end 32D of each sheet segment 32 are arranged at an angle to one another to form a conical shape when the cover 30 is assembled, as shown in FIGS. 3, 4, and 9. However, the present disclosure is not limited in this regard and contemplates embodiments in which the assembled cover 30 has different shapes. For example, in some embodiments, the first lateral end 32C and the second lateral end 32D of each sheet segment 32 are parallel to one another to form a cylindrical shape when the cover 30 is assembled. In some embodiments, the sheet segment 32 is opaque, as shown in FIG. 3. In some embodiments, at least a portion of the sheet segment 32 is transparent or translucent, as shown in FIG. 4.

As shown in FIG. 10, the cover 30 includes a size adjustment arrangement 54 that is configured to selectively fit the cover 30 to a range of sizes of the adapter 10. In some embodiments, the size adjustment arrangement 54 includes a gap 56 that is located between the first flange 36 of the first sheet segment 32 and the second flange 38 of the second sheet segment 32. The gap 56 has a width D1 that is adjustable via the fasteners 42 that extend through the apertures 40 of the first flange 36 and the second flange 38. For example, rotating the fasteners 42 clockwise secures the first flange 36 and the second flange 38 closer together thereby reducing the width D1 of the gap 56. Similarly, rotating the fasteners 42 counterclockwise secures the first flange 36 and the second flange 38 farther apart thereby increasing the width D1 of the gap 56.

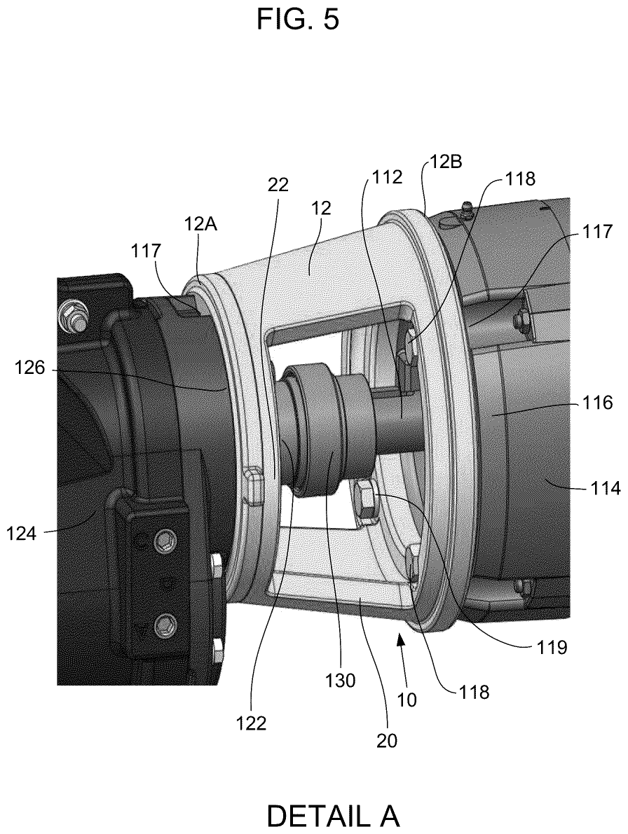

FIGS. 1 and 3-5 show an exemplary rotary drive assembly 100 according to the present disclosure. The rotary drive assembly 100 includes a drive unit 110 (e.g., a motor) and a driven unit 120 (e.g., a gear reducer or gearbox). The drive unit 110 includes a rotatable drive shaft 112 that extends outwardly from a drive unit housing 114. The drive unit housing 114 surrounds the drive shaft 112 and has a first axially facing mounting arrangement 116 thereon. The driven unit 120 includes a rotatable driven shaft 122 that extends outwardly from a driven unit housing 124. The driven unit housing 124 surrounds the driven shaft 122 and has a second axially facing mounting arrangement 126 thereon. In some embodiments, the first axially facing mounting arrangement 116 and the second axially facing mounting arrangement each include a plurality of apertures 117 that correspond to the apertures 17 of the first fastening feature 14 and the second fastening feature 16 of the adapter 10. When mounting the adapter 10 to the rotary drive assembly 100, the apertures 17 of the adapter are aligned with the apertures 117 of the drive unit housing 114 and the driven unit housing 124 and fasteners 118 (e.g., threaded bolts, screws, etc.) are inserted therethrough, as shown in FIG. 5. In some embodiments, washers 119 are positioned between the fasteners 118 and the adapter 10, as shown in FIG. 5. A coupling 130 is removably secured to the drive shaft 112 and the driven shaft 122 thereby connecting the drive shaft 112 to the driven shaft 122. An adapter 10 as disclosed herein is mounted to the rotary drive assembly 100. The second fastening feature 16 of the adapter 10 is secured to the first axially facing mounting arrangement 116 of the drive unit housing 114 and the first fastening feature 14 of the adapter 10 is secured to the second axially facing mounting arrangement 126 of the driven unit housing 124. As shown in FIGS. 1, 4, and 5, the coupling 130 is positioned in the interior area 18 of the adapter 10 such that the coupling 130 is accessible via the one or more longitudinal openings 20 of the adapter 10. The hollow body 12 of the adapter 10 is adjustable to locate the one or more longitudinal openings 20 in a predetermined position for optimal access (e.g., permitting access around potential external equipment restrictions) to the coupling 130 through the one or more longitudinal openings 20. Thus, the adapter 10 allows the coupling 130 to be inspected, maintained, and/or replaced without removing the drive unit 110 by accessing the coupling 130 through the one or more longitudinal openings 20, thereby increasing the safety of the user inspecting or changing the coupling 130. As shown in FIGS. 3-4, a cover 30 as disclosed herein is installed on the adapter 10.

As will be apparent to those skilled in the art, various modifications, adaptations, and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” “some embodiments,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. An adapter for connecting stationary portions of two housings that are connected via a rotatable shaft; the adapter comprising:
a hollow body extending from a first axial end to a second axial end, a first fastening feature arranged proximate the first axial end and a second fastening feature arranged proximate the second axial end, the hollow body having an interior area extending from a first lateral opening located proximate the first axial end to a second lateral opening located proximate the second axial end; and
at least one longitudinal opening located between the first axial end and the second axial end, the at least one longitudinal opening being configured to access the interior area.

2. The adapter of claim 1, further comprising at least one retainer located on an exterior surface of the hollow body.

3. The adapter of claim 1, wherein the at least one longitudinal opening is configured to receive a removable cover.

4. The adapter of claim 1, wherein the hollow body comprises a drip ledge located proximate at least one of the first axial end and the second axial end.

5. The adapter of claim 1, wherein the hollow body is adjustable to locate the at least one longitudinal opening in a predetermined position.

6. A cover for an adapter for connecting stationary portions of two housings that are connected via a rotatable shaft; the cover comprising:
at least one sheet segment extending longitudinally from a first axial end to a second axial end and extending laterally from a first lateral end to a second lateral end having at least two mounting areas thereon configured to secure the at least one sheet segment over at least a portion of the adapter.

7. The cover of claim 6, wherein the at least two mounting areas comprise a first flange located along the first lateral end and a second flange located along the second lateral end.

8. The cover of claim 7, wherein the first flange and the second flange have at least one aperture extending therethrough for receiving a fastener.

9. The cover of claim 8, wherein at least one of the first flange and the second flange have a fastener retention feature configured to hold the fastener during installation of the cover on the adapter.

10. The cover of claim 9, wherein the fastener retention feature comprises at least one of a washer and nut or a bolt head holder.

11. The cover of claim 6, wherein the at least one sheet segment comprises a gasket secured to at least a portion thereof for sealing against the adapter.

12. The cover of claim 11, further comprising a lip extending around a periphery of the at least one sheet segment for limiting compression of the gasket to a predetermined magnitude.

13. The cover of claim 11, further comprising a recess in an underside of the at least one sheet segment, the recess configured to retain the gasket therein and being defined by a lip for limiting compression of the gasket to a predetermined magnitude.

14. The cover of claim 6, wherein the at least one sheet segment comprises an anti-slip feature thereon.

15. The cover of claim 14, wherein the anti-slip feature comprises a notch formed in a peripheral edge of the at least one sheet segment for axially retaining the cover on the adapter.

16. The cover of claim 6, wherein the at least one sheet segment is opaque.

17. The cover of claim 6, wherein at least a portion of the at least one sheet segment is transparent or translucent.

18. The cover of claim 6, wherein the at least one sheet segment is flexible for selectively forming around the adapter.

19. The cover of claim 6, wherein the first lateral end and the second lateral end are parallel to one another to form a cylindrical shape when the cover is assembled.

20. The cover of claim 6, wherein the first lateral end and the second lateral end are arranged at an angle to one another to form a conical shape when the cover is assembled.

21. An adapter and cover assembly comprising the cover of claim 6 installed on the adapter of claim 1.

22. The assembly of claim 21, wherein the cover comprises a size adjustment arrangement configured to selectively fit the cover to a range of adapter sizes.

23. The assembly of claim 22, wherein the size adjustment arrangement comprises an adjustable gap located between the first flange and the second flange, the gap being adjustable with the fasteners extending through the apertures in the first flange and the second flange.

24. The assembly of claim 21, wherein the at least one retainer located on an exterior surface of the hollow body of the adapter is positioned in the anti-slip feature of the at least one sheet segment of the cover to axially retain the cover on the adapter.

25. The assembly of claim 21, comprising two of the at least one sheet segments wrapped around a respective half of the adapter and each of the two sheet segments being secured to one another by respective ones of the first flange and the second flange and the fasteners.

26. A rotary drive assembly comprising:
a drive unit comprising a rotatable drive shaft extending outwardly from a drive unit housing, the drive unit housing having a first axially facing mounting arrangement thereon and surrounding the drive shaft;
a driven unit comprising a rotatable driven shaft extending outwardly from a driven unit housing, the driven unit housing having a second axially facing mounting arrangement thereon and surrounding the driven shaft;
a coupling removably secured to the drive shaft and the driven shaft thereby connecting the drive shaft to the driven shaft;
the second fastening feature of the adapter of claim 1 secured to the first axially facing mounting arrangement of the drive unit housing and the first fastening feature of the adapter secured to the second axially facing mounting arrangement of the driven unit housing, the coupling being positioned in the interior area of the adapter and accessible via the at least one longitudinal opening of the adapter; and
the cover of claim 6 installed on the adapter.

27. An adapter and cover assembly for connecting stationary portions of two housings that are connected via a rotatable shaft, the adapter comprising:
a support structure extending around the shaft and having a hollow body extending from a first axial adapter-end to a second axial adapter-end, a first fastening feature arranged proximate the first axial adapter-end and a second fastening feature arranged proximate the second axial adapter-end, the hollow body having an interior area extending from the first axial adapter-end to the second axial adapter-end, the first axial adapter-end having a first lateral opening and the second axial adapter-end having a second lateral opening; the first fastening feature fixedly connected to a first of the two housings and the second fastening feature fixedly connected to a second of the two housings; and
a longitudinal opening located between the first axial adapter-end and the second axial adapter-end, the longitudinal opening being in communication with the interior area; and
the cover comprising a sheet segment extending longitudinally from a first axial cover-end to a second axial cover-end and extending laterally from a first lateral cover-end to a second lateral cover-end having at least two mounting areas removably secured to the adapter and the at least two mounting areas comprise a first flange located along the first lateral end and a second flange located along the second lateral end;
a gasket positioned between the sheet segment and the adapter;
wherein a lip extends around a periphery of the sheet segment for limiting compression of the gasket to a predetermined magnitude, so that the cover is removably and sealably secured over the longitudinal opening in the adapter by mating of the first flange and the second flange.
